(19) United States
(12) Patent Application Publication
(10) Pub. No.: US 2025/0265059 A1
(43) Pub. Date: Aug. 21, 2025

(54) APPLICATION OPTIMIZATION THROUGH CONTAINER IMAGE WASM CONVERSION

(71) Applicant: Red Hat, Inc., Raleigh, NC (US)

(72) Inventors: Brian Gallagher, Waterford (IE); Laura Fitzgerald, Waterford (IE)

(21) Appl. No.: 18/581,152

(22) Filed: Feb. 19, 2024

(51) Int. Cl. G06F 8/41; G06F 11/36

(52) U.S. Cl. CPC G06F 8/447; G06F 8/433; G06F 11/3688; G06F 11/3692

(57) ABSTRACT

A computing system comprising one or more computing devices accesses a container build file comprising a plurality of instructions for building a container image based at least in part on an instruction file that defines an application. The computing system identifies a programming language in which the instruction file was written. The computing system determines that the programming language is a member of a set of programming languages that can be compiled into a WebAssembly (WASM) binary code format. The computing system causes the instruction file to be compiled into the WASM binary code format.

### BACKGROUND

A container image is a standalone executable package of software that includes everything needed to run an application. A container image typically includes an application and one or more dependencies needed for the application to run, such as system tools, system libraries, and the like. A container build file is a file comprising one or more instructions for building a container image. A container, which can be initiated from a container image, is an isolated operating environment that typically includes a running instance of an application and any dependencies needed for the application to run.

### SUMMARY

Examples provided herein can automatically convert an application associated with a container build file to a WebAssembly (WASM) binary format.

In one implementation, a method is provided. The method includes accessing, by a computing system comprising one or more computing devices, a container build file comprising a plurality of instructions for building a container image based at least in part on an instruction file that defines an application. The method further includes identifying, by the computing system, a programming language in which the instruction file was written. The method further includes determining, by the computing system, that the programming language is a member of a set of programming languages that can be compiled into a WebAssembly (WASM) binary code format. The method further includes causing, by the computing system, the instruction file to be compiled into the WASM binary code format.

In another implementation, a non-transitory computer-readable storage medium is provided. The non-transitory computer-readable storage medium includes executable instructions to cause a processor device to access a container build file comprising a plurality of instructions for building a container image based at least in part on an instruction file that defines an application. The executable instructions further cause the processor device to identify a programming language in which the instruction file was written. The executable instructions further cause the processor device to determine that the programming language is a member of a set of programming languages that can be compiled into a WebAssembly (WASM) binary code format. The instructions further cause the processor device to cause the instruction file to be compiled into the WASM binary code format.

In another implementation, a computing system is provided. The computing system includes one or more computing devices to access a container build file comprising a plurality of instructions for building a container image based at least in part on an instruction file that defines an application. The computing devices further identify a programming language in which the instruction file was written. The computing devices further determine that the programming language is a member of a set of programming languages that can be compiled into a WebAssembly (WASM) binary code format. The computing devices further cause the instruction file to be compiled into the WASM binary code format.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which application optimization through container image WASM conversion may be practiced;

FIG. 2 is a flowchart of a method for application optimization through container image WASM conversion according to one example;

FIG. 3 is a simplified block diagram of the environment illustrated in FIG. 1 according to one implementation;

FIG. 4 is a flowchart diagram of a method for application optimization through container image WASM conversion according to another example; and

FIG. 5 is a block diagram of a computing device suitable for implementing application optimization through container image WASM conversion according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Containerization is a virtualization technology enabling software applications to be run in standalone “containers” that can be isolated from other containers (e.g., other containers running on the same computing device). A container can include a running software application and any other aspects of an operating environment (e.g., necessary files, environmental variables, system tools, system libraries, etc.) that the software application may need to properly run. Because a container can include everything a software application needs to properly run, containerization can allow a software application to be portable from computer to computer, without requiring any reconfiguration of each computer's operating environment. Additionally, a container's isolation from other containers can allow multiple applications to operate on the same computer, even if the applications have conflicting operating requirements. This isolation and portability can make containerization particularly useful in an enterprise computing environment or cloud computing environment, where a computing provider may serve a large number of users and host a large number of software applications, which may have a large number of differing operating requirements.

WebAssembly (WASM) is a binary code format that can also be portable from computer to computer in combination with a WASM runtime environment, which can provide the necessary operating environment for a WASM-formatted software application to run. In some instances, WASM can have performance advantages and security advantages over alternative object code formats. As a non-limiting illustrative example, some applications written in the Java programming language may run more efficiently (e.g., faster, using less processing power, using less storage space, etc.) when compiled into a WASM binary format and run in a WASM runtime environment, as compared to a Java bytecode format run in a Java Virtual Machine (JVM) runtime environment.

In some instances, it may be desirable to convert a non-WASM application into a WASM binary format (e.g., to test whether a WASM-formatted application runs more efficiently than a legacy non-WASM application). However, converting an application according to existing methods may in some instances be labor-intensive and may require knowledge that a user may not have. For example, converting to WASM can require a case-by-case analysis of an application's code (e.g., source code) to determine whether it is even possible to convert the application to a WASM binary format. And once an application has been determined to be WASM-compatible, compiling the application into a WASM binary format may require a series of commands (e.g., “RUN cargo build—target wasm32—release”, etc.) that may need to be determined on a case-by-case basis for each application. In some instances, a user may lack the knowledge required to analyze and convert an application to a WASM binary format, which can be a barrier preventing legacy applications from being converted to a more computationally efficient format.

The examples set forth below can automatically convert a container-based application to a WASM binary format, with little or no human intervention. For example, a computing system can access a container build file and identify a programming language in which the instruction was written. The computing system can automatically determine whether the programming language is compatible with the WASM binary format. If it is, the computing system can automatically perform any necessary steps to cause the application to be compiled into a WASM binary format (e.g., sending appropriate commands to an appropriate compilation tool, etc.).

In some implementations, the examples set forth below can perform additional conversion steps to handle particular types of WASM conversions. For example, some container build files may include particular runtime dependencies (environmental variables, system tools, system libraries, etc.) that a non-WASM containerized application may need to run properly, or compile-time dependencies that may be needed to compile the application properly. Some examples set forth below can automatically determine whether such dependencies are WASM-compatible. In some implementations, the examples set forth below can automatically replace a non-WASM-compatible dependency with a WASM-compatible equivalent.

In some implementations, the examples set forth below can perform additional actions that may be valuable for a user or computing provider using containerized applications. For example, some implementations set forth below can automatically run and test a converted WASM application to determine whether it is running properly and whether it is more efficient than a non-WASM alternative. In some implementations, such tests can be automatically performed in a standard container management environment, such that a user can automatically convert and test WASM applications with little or no investment (e.g., labor investment, IT investment, etc.) in WASM-specific infrastructure.

The examples set forth below can provide a variety of technical effects and benefits. For example, some implementations set forth below can reduce a computational cost (e.g., electricity cost, processor usage, memory usage, etc.) associated with running a software application by automatically converting the application from a higher-computational-cost format to a WASM binary format, with little or no human intervention. In some implementations, the examples set forth below can reduce a computational cost (e.g., electricity cost, processor usage, memory usage, etc.) associated with converting and testing a WASM-formatted application. For example, some implementations enable a user or computing provider to test a WASM-formatted application in a standard container management environment, which can reduce a computational cost (e.g., memory usage, etc.) associated with installing WASM-specific infrastructure. In some implementations, the examples set forth below can also reduce an error rate associated with a WASM conversion process (e.g., by automatically detecting WASM compatibility issues; by automatically identifying and using appropriate tools, commands, and dependencies in the conversion process; etc.). A reduced error rate can, in turn, reduce a computational cost of WASM conversion by reducing a number of failed conversion attempts, which can waste computational resources. Additionally, the examples set forth below can in some instances reduce a labor cost and other financial costs of converting an application to a WASM binary format.

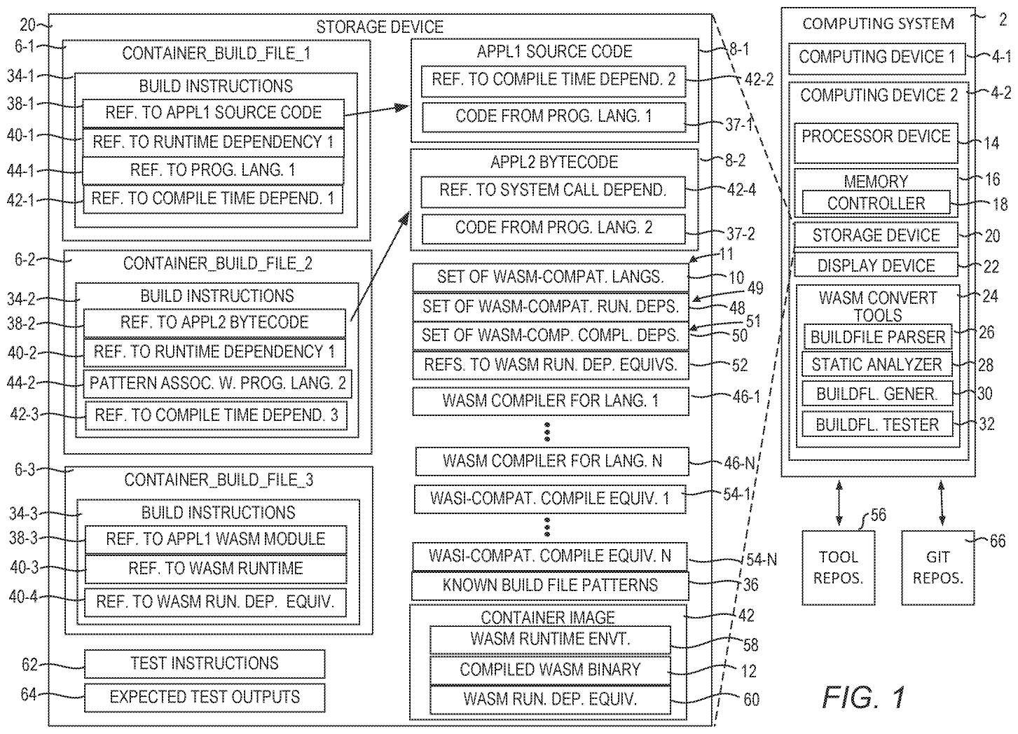

FIG. 1 is a block diagram of a computing system 2 to convert a container build file 6-1 or 6-2 into a WASM binary format. The computing system 2 can include computing devices 4-1, 4-2 to convert a container build file 6-1 or 6-2 to a WASM binary format. For example, the computing device 4-2 can identify a programming language in which an instruction file 8-1 or 8-2 was written. The computing device 4-2 can determine that the programming language is a member of a set of WASM-compatible programming languages 10 that can be compiled in a WASM binary format. The computing device 4-2 can cause the build file 6-1 or 6-2 to be compiled into the WASM binary format to generate a compiled WASM binary 12.

The computing system 2 can include one or more computing devices 4-1, 4-2. The computing devices can be connected to each other, such as via a network (e.g., internet, local area network, wide area network, etc.), or not.

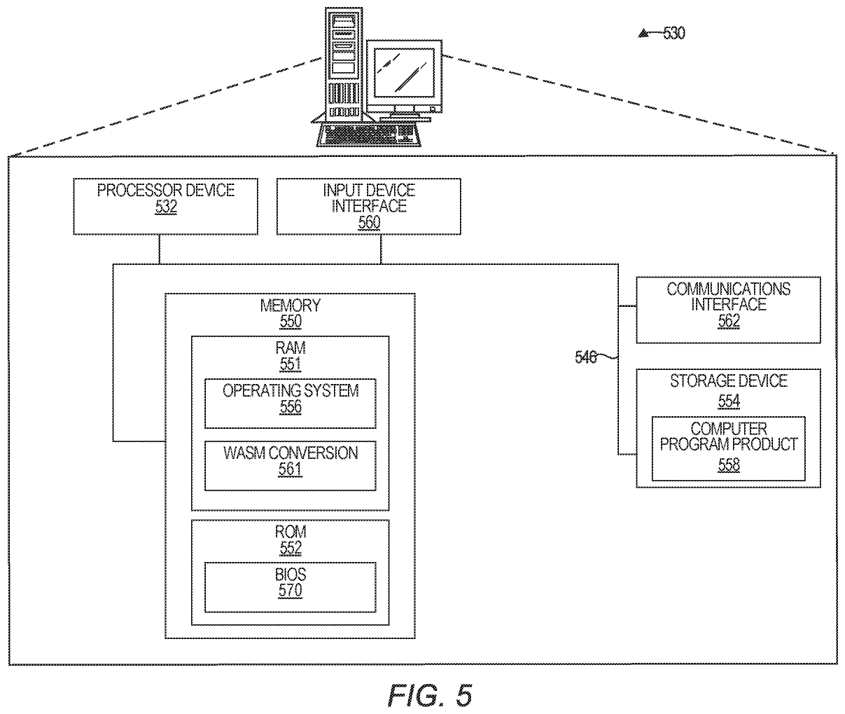

A computing device 4-1, 4-2 may comprise any computing or electronic device capable of including firmware, hardware, and/or executing software instructions to implement the functionality described herein, such as a computer server, a desktop computing device, a laptop computing device, a smartphone, a computing tablet, or the like. Each computing device 4-1, 4-2 can include one or more processor devices 14, memories 16 comprising a memory controller 18, storage devices 20, or display devices 22. In some implementations, a computing device 4-1, 4-2 can contain WASM conversion tools 24, such as a build file parser 26, static analyzer 28, build file generator 30, and build file tester 32. In some implementations, a computing device 4-1, 4-2 can include a client device or a server device. Additional example implementation details for a computing device 4-1 are provided below with respect to FIG. 5.

A container build file 6-1 or 6-2 (e.g., Dockerfile, etc.) can include, for example, a plurality of build instructions 34-1, 34-2 for building a container image (e.g., Docker image, etc.). An instruction file 8-1 or 8-2 can be or include a file containing a plurality of computer-readable instructions defining an application associated with a container build file 6-1 or 6-2. In some implementations, the computer-readable instructions can comprise a source code file 8-1 or bytecode file 8-2.

A set of WASM-compatible programming languages 10 can be, for example, a set of programming languages that can be compiled into a WASM binary format. Data indicative of the set of WASM-compatible programming languages 10 can be stored in any appropriate data structure, such as a database, file, memory locations or storage locations, data object or data collection (e.g., list, array, stack, etc.), etc. Data indicative of the set of WASM-compatible programming languages 10 can be stored locally by a computing device 4-2 (e.g., on a storage device 20), retrieved from another device (e.g., via a network connection), or any combination thereof. Example data structures indicative of the set of WASM-compatible programming languages 10 are further discussed below.

A compiled WASM binary 12 can be, for example, a file comprising an application compiled into a WASM binary format for execution in a WASM runtime environment. A compiled WASM binary 12 can be referred to as a WASM module.

A processor device 14, memory 16, memory controller 18, storage device 20, or display device 22 can in some implementations be standard components constructed according to known methods. Additional example implementation details for an example processor device 14, memory 16, memory controller 18, storage device 20, or display device 22 are provided below with respect to FIG. 5.

WASM conversion tools 24 can include, for example, one or more hardware or software components to perform WASM conversion actions, such as the example actions described herein. WASM conversion tools 24 can include, for example, non-transitory computer-readable media storing executable instructions that, when executed, cause the computing device 4-1 or processor device 6 to perform one or more actions. Because the WASM conversion tools 24 are components of the computing device 4-2, functionality implemented by the WASM conversion tools 24 may be attributed to the computing device 4-2 generally. Moreover, in examples where the WASM conversion tools 24 comprise software instructions that program the processor device 14 to carry out functionality discussed herein, functionality implemented by the WASM convert tools 24 may be attributed herein to the processor device 14.

It is further noted that while the build file parser 26, static analyzer 28, build file generator 30, and build file tester 32 are shown as separate components, in other implementations, the build file parser 26, static analyzer 28, build file generator 30, and build file tester 32 could be implemented in a single component or could be implemented in a number of components greater than or less than four.

In some implementations, a build file parser 26 can be a WASM conversion tool 24 to analyze a container build file 6-1 or 6-2 to determine whether an application associated with the container build file 6-1 or 6-2 can be compiled into a WASM binary format. In some implementations, a static analyzer 28 can be a WASM conversion tool 24 to analyze an instruction file 8-1, 8-2 to determine whether an application defined by the instruction file 8-1, 8-2 can be compiled into a WASM binary format. In some implementations, a build file generator 30 can be a WASM conversion tool 24 to generate a container build file 6-3 comprising a reference 38-3 to a compiled WASM binary 12. In some implementations, a build file tester 32 can be a WASM conversion tool 24 to test a container build file 6-3. The build file parser 26, static analyzer 28, build file generator 30, and build file tester 32 can each include, for example, one or more hardware or software components having any or all of the properties of a WASM conversion tool 24.

Analyzing the container build file 6-1 or 6-2 can include identifying an instruction file 8-1 or 8-2 associated with the container build file 6-1 or 6-2, wherein the instruction file 8-1 or 8-2 defines an application. In some implementations, a build file parser 26 can read a container build file 6-1, 6-2 to identify the instruction file 8-1, 8-2 that defines an application. In some implementations, the build file parser 26 can identify the instruction file 8-1, 8-2 based on one or more known build file patterns 36 associated with running an application file. In some implementations, a known build file pattern 36 can include a known command for running an application (e.g., CMD [“java”, . . . ], etc.) or a known file extension associated with a type of application (e.g., .exe file extension, etc.). The build file parser 26 can, for example, extract a file extension or command from the container build file 6-1, 6-2 and compare the extracted item to a stored dataset of known build file patterns 36. For example, extracting a file extension can include parsing the container build file 6-1, 6-2 (e.g., using a regular expression, etc.) based on one or more delimiters (e.g., period character “.”, slash or backslash character “/”, “\”, newline or other whitespace character, etc.). For example, if a container build file 6-1, 6-2 contains a string containing a period followed by one or more alphanumeric characters and a whitespace character, the combination of the period and the alphanumeric characters can be identified as a file extension. Once a file extension is extracted, it can be compared to a set of known application file extensions included in the known build file patterns 36. Similarly, extracting a command from the container build file 6-1, 6-2 can include parsing the container build file 6-1, 6-2 based on one or more delimiters (e.g. “CMD”, “RUN”, etc.). For example, a Docker container can in some implementations be parsed to identify lines beginning with “CMD” followed by, for example, one or more parameters enclosed in brackets “[”, “]” and a newline character. In such instances, a first parameter of the inside the brackets can be identified as a command to be compared to a set of known commands in the known build file patterns 36. In such instances, a filename associated with the command or file extension can be identified as a reference 38-1, 38-2 to an instruction file 8-1, 8-2.

Analyzing the container build file 6-1 can include identifying a programming language in which the instruction file 8-1, 8-2 was written. In some implementations, identifying the programming language can include parsing the container build file 6-1, 6-2 in the same manner described above. For example, in some implementations, a command or file extension extracted from the container build file 6-1, 6-2 can be identified as a command or file extension associated with a particular language.

For example, in some implementations, the known build file patterns 36 can include data structures correlating a build file pattern (e.g., file extension, command, compiler program, package manager, runtime environment, etc.) with a particular language. In some implementations, data structures indicative of the known build file patterns 36 can correlate a build file pattern to additional metadata, such as whether or not the build file pattern is associated with an instruction file 8-1, 8-2 defining an application; a compile-time dependency 42-1 to 42-2; or a runtime dependency 40-1, 40-2. In some implementations, a build file parser 26 can identify, in a container build file 6-1 or 6-2, data indicative of a programming language (e.g., a reference to a particular programming language 44-1, a pattern associated with a particular programming language 44-2, etc.) based on one or more known build file patterns 36. A reference to a programming language 44-1 can include, for example, computer-readable data referring to the programming language (e.g., “java”, etc.), while a pattern associated with a particular programming language 44-2 can be, for example, computer-readable data associated with the programming language that is not expected to appear in container build files 6-1, 6-2 or instruction files 8-1, 8-2 that do not use the programming language. For example, in some implementations, a build file parser 26 can search a container build file 6-1, 6-2 for one or more known build file patterns 36 indicative of a programming language (e.g., “java”, “javac”, “cargo”, “.py”, etc.). In some implementations, a build file parser 26 can parse a container build file 6-1, 6-2 to extract one or more patterns of interest (e.g., file extensions, commands following “RUN”, commands following “CMD”, etc.), and the build file parser 26 can search the known build file patterns 36 for a data entry associated with an extracted pattern of interest.

As a non-limiting illustrative example, a container build file 6-1, 6-2 containing an instruction starting with “RUN cargo” may be identified as being associated with the RUST programming language by extracting the name “cargo”; retrieving a data entry associated with the pattern “cargo” from the known build file patterns 36; and determining, based on the data entry, that “cargo” is associated with the RUST programming language. Alternatively, a container build file 6-1, 6-2 containing an instruction starting with “RUN cargo” may be identified as being associated with the RUST programming language by accessing a “cargo” entry from the known build file patterns 36 data structure, wherein the “cargo” entry indicates that the term “cargo” is associated with the RUST programming language, and searching a container file 6-1, 6-2 for strings comprising the term “cargo”.

In some implementations, identifying a programming language in which the instruction file 8-1, 8-2 was written can include additional actions beyond parsing the container build file 6-1, 6-2. For example, in some implementations, a container build file 6-1, 6-2 can be parsed to identify, for example, a folder or directory in which an instruction file 8-1, 8-2 is contained, and data extracted from the folder or directory (e.g. filenames, file extensions, etc.) can be compared to known build file patterns 36. In some implementations, one or more additional files (e.g., files referenced by the container build file 6-1, 6-2, etc.) can be parsed in a manner similar to (e.g., same as) the manner described above for parsing container build files 6-1, 6-2, and patterns extracted from the additional files can be compared to known build file patterns 36. In some implementations, identifying a programming language in which the instruction file 8-1, 8-2 was written can include identifying data indicative of the programming language (e.g., pattern associated with the language 44-2, reference to the language 44-1, code written in the programming language 37-1, 37-2, etc.) in the instruction file 8-1, 8-2.

Analyzing the container build file 6-1, 6-2 can include determining whether or not the identified programming language is a member of a set of WASM-compatible programming languages 10 that can be compiled into a WASM binary format. This can be performed, for example, by comparing the identified programming language to a data structure 11 defining a set of programming languages that can be compiled into a WASM binary format. In some implementations, a data structure 11 defining the set of WASM-compatible programming languages can include a plurality of data entries, with each entry correlating a programming language to WASM compatibility data. In some implementations, the WASM compatibility can include boolean (e.g. “yes” or “no”; “true” or “false”; etc.) or similar data indicating that a programming language can or cannot be compiled into a WASM binary format. In some implementations, the compatibility data can include additional data, such as a reference (e.g., filename; numerical identifier; location such as URL, memory location, git repository location, etc.; or the like) to a WASM compiler 46-1 or 46-N to compile an instruction file 8-1, 8-2 into a WASM binary format. In some implementations, a data structure 11 defining a set of programming languages that can be compiled into a WASM binary format can comprise a plurality of data entries for each language (e.g., one language can be associated with more than one WASM compiler 46-1 to 46-N, etc.).

In some implementations, a computing device 4-2 can retrieve a data entry associated with an identified programming language from a data structure 11 comprising WASM compatibility information for a plurality of programming languages. For example, data indicative of the programming language (e.g., programming language name, numerical programming language identifier, etc.) can be retrieved from the known build file patterns 36 by the build file parser 26, and the computing device 4-2 can retrieve a data entry corresponding to the programming language from the data structure 11 based on the data indicative of the programming language (e.g., using a database retrieval command, such as SELECT*WHERE langName=′Java′, etc.).

In some implementations, the computing device 4-2 can determine whether the identified programming language can be compiled into a WASM binary format based on a retrieved data entry associated with the programming language. In some implementations, the data entry may include boolean WASM compatibility data (e.g., “true”, “false”, etc.) and the computing device 4-2 can determine that the identified programming language can be compiled into a WASM binary format based solely on the boolean compatibility data. In other instances, the data entry may include other WASM compatibility data, such as a list of available WASM compilers for the language. If no WASM compilers for a language exist, then the language is not a member of the set of languages that can be compiled into a WASM binary format. If WASM compilers exist, then the computing device 4-2 can either determine that the language can be compiled into the WASM binary format or can perform further analysis steps. For example, in some implementations, the WASM compatibility information can include access data or licensing data associated with a WASM compiler 46-1 to 46-N (e.g., access permissions list; licensing cost; licensing terms; data indicating whether a user already has a license to use a particular WASM compiler; etc.). Such access data or licensing data can be used to determine whether the WASM compiler can or should be used for a particular user. In some implementations, licensing data can be compared to a policy associated with a user or client (e.g., individual, organization, etc.) to determine whether the language can be compiled into a WASM binary format by or for that user or client. For example, a non-commercial open-source license may in some instances be unsuitable for a commercial client such as an enterprise company. Similarly, a paid or high-cost license may be unsuitable for some users.

In some instances, a computing device 4-2 may determine that a language cannot be compiled into a WASM binary format and may return a user message indicating that the container build file NN could not be converted to a WASM format. In other instances, a computing device 4-2 may determine that a language can be compiled into a WASM binary format, and may perform additional actions (e.g., as described in the examples set forth below).

In some implementations, analyzing the container build file 6-1, 6-2 can include identifying one or more dependencies (e.g., runtime dependencies 40-1, 40-2; compile-time dependencies 42-1, 42-3) associated with the container build file 6-1, 6-2. In some implementations, a build file parser 26 can identify a runtime dependency 40-1, 40-2 or compile-time dependency 42-1, 42-3 (e.g., library, framework, runtime environment, database, environmental variable, configuration data, etc.) associated with a container build file 6-1, 6-2 by identifying an instruction to configure a computing environment associated with the container build file 6-1, 6-2 (e.g., computing environment in which an instruction file 8-1, 8-2 is compiled; computing environment associated with a container initialized from a container image built from the container build file 6-1, 6-2; etc.). Configuring a computing environment can include, for example, installing or loading a file (e.g., library, package, framework, module, data file, configuration file, container image, etc.) or other data component or software component. Configuring a computing environment can also include, for example, setting or updating an environmental variable (e.g., present working directory or file path, etc.). Configuring a computing environment can also include, for example, loading a particular software process, application, or thread (e.g., Java Virtual Machine runtime environment or other runtime environment, database application, web hosting service on localhost, etc.). In some implementations, an instruction to configure a computing environment can include an instruction to load a base container image or parent container image. In some implementations, a base container image or parent container image can include a runtime environment and/or one or more other runtime dependencies.

In some implementations, a build file parser 26 can identify an instruction to configure a computing environment of the container based on one or more known build file patterns 36 associated with configuring a computing environment. In some implementations, a known build file pattern 36 can include a known command for loading or installing a dependency or for configuring an environmental variable (e.g., “apt-get install”, “setenv”, etc.). The build file parser 26 can, for example, extract an environmental configuration command and identify a dependency based on the environmental configuration command. In some implementations, extracting an environmental configuration command can include parsing the container build file 6-1, 6-2 (e.g., using a regular expression, etc.) based on one or more delimiters (e.g., “apt-get”, “install”, “setenv”, “open”, “pip”, newline character, etc.) or searching the container build file for one or more strings of interest. In some implementations, an environmental configuration command can include a command name (e.g., “install”, etc.) and one or more parameters associated with the command. In some cases, the parameters can include data identifying a particular dependency (e.g., filename, package name, package identifier, etc.), and a build file parser 26 can identify a dependency based on the environmental configuration command.

If a runtime dependency is identified, analyzing the container build file 6-1, 6-2 can include determining whether the runtime dependency is a member of a set of WASM-compatible runtime dependencies 48.

Determining whether a runtime dependency is a member of a set of WASM-compatible runtime dependencies 48 can include, for example, comparing an identified runtime dependency to a data structure 49 defining the set of runtime dependencies that can be used in combination with a WASM runtime environment, either as-is or by substituting a WASM-compatible equivalent for the runtime dependency. In some implementations, data structure 49 defining the set of WASM-compatible runtime dependencies can include a plurality of data entries, with each entry correlating a runtime dependency to WASM compatibility data. In some implementations, the WASM compatibility data can include boolean data (e.g. “yes” or “no”; “true” or “false”; etc.) or similar data indicating that a runtime dependency can or cannot be loaded in a WASM runtime environment. In some implementations, the compatibility data can include additional data, such as references 52 to one or more WASM equivalents 60 to the runtime deficiency. In some implementations, the data structure 49 can include a plurality of data entries for each runtime dependency (e.g., when a runtime dependency is associated with more than one WASM equivalent, etc.)

In some implementations, a computing device 4-2 can retrieve a data entry associated with an identified runtime dependency from a data structure 49 comprising WASM compatibility information for a plurality of runtime dependencies. For example, data indicative of the runtime dependency (e.g., runtime dependency name, file name, numerical identifier, etc.) can be retrieved from the container build file 6-1, 6-2 by the build file parser 26, and the computing device 4-2 can retrieve a data entry corresponding to the runtime dependency from the data structure 49 based on the data indicative of the runtime dependency (e.g., using a database retrieval command, such as SELECT*WHERE dependencyName=′jvm.dll′, etc.).

In some implementations, the computing device 4-2 can determine whether an identified runtime dependency 40-1, 40-2 is WASM-compatible based on a retrieved data entry associated with the runtime dependency 40-1, 40-2. In some implementations, the data entry may include boolean WASM compatibility data (e.g., “true”, “false”, etc.) and the computing device 4-2 can determine that the identified programming language is compatible based solely on the boolean compatibility data. In other instances, the data entry may include other WASM compatibility data, such as references 52 to available WASM equivalents 60 for the runtime dependency. A WASM equivalent 60 can include, for example, a runtime dependency configured to perform functions in a WASM runtime environment 58 that are similar to (e.g., same as) functions performed by a runtime dependency 40-1, 40-2 in a non-WASM runtime environment. In some implementations, a WASM equivalent 60 can share additional properties with a non-WASM runtime dependency 40-1, 40-2 such that the WASM equivalent 60 is interchangeable with the non-WASM runtime dependency 40-1, 40-2. For example, the WASM equivalent 60 can have an interface (e.g., API, method signature, method name, parameter count and type, etc.) that is the same as an interface of the runtime dependency 40-1, 40-2, or can otherwise be callable using similar (e.g., same) parameters compared to a runtime dependency 40-1, 40-2. If WASM equivalents 60 exist, then the computing device 4-2 can either determine that the runtime dependency can be replaced with a WASM equivalent 60 or can perform further analysis steps. For example, in some implementations, the WASM compatibility information can include licensing data or access data associated with the WASM equivalent 60, which can be used to determine whether a WASM equivalent 60 is available to a user or client (e.g., by comparing licensing data to a licensing policy associated with the user or client, etc.).

Similarly, if a compile-time dependency 42-1, 42-3 is identified based on the container build file 6-1, 6-2, analyzing the container build file 6-1, 6-2 can include determining whether the compile-time dependency 42-1, 42-3 is a member of a set of WASM-compatible compile-time dependencies 50. In some implementations, this determination can be made according to examples set forth below (e.g., with respect to static code analysis by the static analyzer 28), or can be made in a manner similar to (e.g., same as) a manner for determining whether a runtime dependency 40-1, 40-2 is a member of a set of WASM-compatible runtime dependencies 48.

In some implementations, a computing device 4-2 may determine that a dependency identified based on the container build file 6-1, 6-2 is not WASM-compatible and may return a user message indicating that the container build file 6-1, 6-2 could not be converted to a WASM format. In other instances, a computing device 4-2 may determine that a dependency is WASM-compatible, and may perform additional actions (e.g., as described in the examples set forth below).

If a computing device 4-2 determines that a language can be compiled into a WASM binary format, the computing device 4-2 can in some implementations determine whether a static code analysis is required to identify any compile-time dependencies 42-2, 42-4 (e.g., libraries, packages, frameworks, modules, data files, configuration files, etc.) referenced in an instruction file 8-1, 8-2. For example, in some instances, WASM compatibility information in the data structure 11 may indicate that a language is fully compatible with a WASM binary format, such that a particular compiler can convert any code in the programming language into a WASM format. In other instances, WASM compatibility information in the data structure 11 may identify a particular compile-time dependency, group of dependencies, or category of dependency that may be incapable of being directly compiled into a WASM binary format. As a non-limiting illustrative example, a language (e.g., Java, etc.) may be identified as being compatible with some dependencies (e.g., packages or libraries comprising system calls, packages or libraries for interacting with native hardware, etc.) that a particular WASM compiler is not configured to directly compile into a WASM binary format for use in a WASM runtime environment. In such instances, a data structure 11 or data structure 51 comprising WASM compatibility data for a language may identify, for example, particular dependencies (e.g., packages or libraries comprising system calls, etc.) as potentially WASM-incompatible dependencies associated with the language. When a risk of incompatible dependencies exists, a static code analysis can be run to check for WASM-incompatible dependencies.

In some implementations, a static analyzer 28 can analyze an instruction file 8-1, 8-2 to identify one or more compile-time dependencies (e.g., packages, libraries, modules, etc.) referenced in the instruction file 8-1, 8-2. In some implementations, analyzing an instruction file 8-1, 8-2 can include parsing the instruction file 8-1, 8-2 based on one or more delimiters. For example, in some implementations, a syntax associated with an identified programming language can include a particular keyword (e.g., “import”, “using”, etc.) for introducing certain types of dependencies (e.g., packages, libraries, etc.) used by the instruction file 8-1, 8-2. In such instances, a compile-time dependency can be identified by parsing (e.g., using a regular expression) the instruction file 8-1, 8-2 to identify lines of code associated with (e.g., beginning with) the keyword. In some implementations, a computing device 4-2 can identify text appearing immediately after the keyword as a name of a compile-time dependency.

In some implementations, a static analyzer 28 can determine whether an identified compile-time dependency is a member of a set of WASM-compatible compile-time dependencies 50. For example, the static analyzer 28 can compare the identified programming language to a data structure 51 defining the set of WASM-compatible compile-time dependencies. In some implementations, data structure 51 defining the set of WASM-compatible compile-time dependencies can include a plurality of data entries, with each entry correlating a compile-time dependency 42-2, 42-4 to WASM compatibility data. In some implementations, the WASM compatibility can include boolean data (e.g. “yes” or “no”; “true” or “false”; etc.) or similar data indicating that a compile-time dependency can or cannot be compiled into a WASM binary format. In some implementations, the compatibility data can include additional data, such as a reference to one or more WASM compilers 46-1 to 46-N to compile a compile-time dependency 42-2, 42-4 into a WASM binary format, or a reference to one or more WASM-compatible substitutes for the compile-time dependency (e.g., WASI-compatible compile-time equivalents 54-1 to 54-N, etc.). In some implementations, the data structure 51 can include a plurality of data entries for each compile-time dependency (e.g., when a compile-time dependency is associated with more than one WASM compiler, etc.)

In some implementations, a computing device 4-2 can retrieve a data entry associated with an identified compile-time dependency from a data structure 51 comprising WASM compatibility information for a plurality of compile-time dependencies. For example, data indicative of a compile-time dependency (e.g., name, numerical identifier, etc.) can be retrieved by the static analyzer 28 (e.g., from the instruction file 8-1), and the computing device 4-2 can retrieve a data entry corresponding to the compile-time dependency from the data structure 51 based on the data indicative of the compile-time dependency (e.g., using a database retrieval command, such as SELECT*WHERE dependName=′jni.h′, etc.).

In some implementations, the computing device 4-2 can determine whether the identified compile-time dependency is WASM-compatible based on a retrieved data entry associated with the compile-time dependency. In some implementations, the data entry may include boolean WASM compatibility data (e.g., “true”, “false”, etc.) and the computing device 4-2 can determine that the identified compile-time dependency is compatible based solely on the boolean compatibility data. In other instances, the data entry may include other WASM compatibility data, such as a list of available WASM compilers or WASM-compatible substitutes for the compile-time dependency. If no WASM compilers or WASM-compatible substitutes exist, then the compile-time dependency is not a member of the set of compile-time dependencies that can be compiled into a WASM binary format. If WASM compilers or WASM-compatible substitutes exist, then the computing device 4-2 can either determine that the language can be compiled into the WASM binary format or can perform further analysis steps. In some implementations, access data or licensing data associated with a WASM compiler or WASM-compatible substitute can be compared to a licensing policy associated with a user or client. In some implementations, WASM compatibility data of a plurality of dependencies can be compared, and an overall WASM compatibility determination can be made based on the comparison. For example, if an instruction file contains a plurality of compile-time dependencies, and no available WASM compiler 46-1 to 46-N can compile all of the compile-time dependencies, then the computing device 4-2 may determine that the instruction file 8-1, 8-2 cannot be compiled into a WASM binary format.

In some implementations, a WASM equivalent 60, 54-1 to 54-N can comprise a replacement dependency (e.g., replacement library, etc.) having an interface (e.g., API, etc.) that is similar to (e.g., same as) an interface of a non-WASM dependency being replaced. In some implementations, substituting such a dependency can include replacing the dependency in an object model file (e.g., pom.xml file) associated with an application. In some implementations, a WASM equivalent 60, 54-1 to 54-N can include a plurality of bindings (e.g., Java-to-WASI bindings, etc.) to map a plurality of respective non-WASM functions to a plurality of respective WASM functions. Bindings can include, for example, wrapper functions, wrapper libraries, APIs, and the like. In some implementations, custom bindings can be developed (e.g., for a dependency that would otherwise be WASM-incompatible).

In some implementations, a computing device 4-2 may determine that a compile-time dependency 42-2, 42-4 cannot be compiled into a WASM binary format, and may return a user message indicating that the container build file 6-1, 6-2 could not be converted to a WASM format. In other instances, a computing device 4-2 may determine that a compile-time dependency 42-2, 42-4 can be compiled into a WASM binary format, and may perform additional actions (e.g., as described in the examples set forth below).

In some implementations, a computing device 4-2 can cause an instruction file 8-1, 8-2 associated with a container build file 6-1, 6-2 to be compiled into a WASM binary format to generate a compiled WASM binary 12. For example, in some implementations, the computing device 4-2 can identify an appropriate WASM compiler 46-1 to 46-N to compile the programming language in which the instruction file 8-1, 8-2 was written into a WASM binary format, and cause the identified WASM compiler 46-1 to 46-N to be run. In some implementations, the WASM compilers 46-1 to 46-N can be stored by the computing device 4-2 in a storage device 20, memory 16, or other non-transitory computer-readable media. In some implementations, the WASM compilers 46-1 to 46-N can be stored in or retrieved from a tool repository 56, which may be part of the same computing system 2 as the computing device 4-2 or a different computing system. In some implementations, a tool repository may be distributed across multiple computing systems (e.g., internet websites, git repositories, etc.). For example, in some implementations, a computing device 4-2 may store data describing a plurality of WASM compilers 46-1 to 46-N stored on a plurality of computing systems or devices. Data describing a WASM compiler 46-1 to 46-N can include, for example, a location of the WASM compiler 46-1 to 46-N(e.g., URL, address, file location, git repository location, etc.); a command or instruction for activating the WASM compiler (e.g., HTTP request or other network request; Linux or Windows command-line command; container build instruction; etc.); and any other relevant data associated with the WASM compiler 46-1 to 46-N. Causing a WASM compiler tool 46-1 to 46-N to be run can include, for example, running the WASM compiler tool 46-1 to 46-N on the computing device 4-2 or causing another computing device to run the WASM compiler tool 46-1 to 46-N (e.g., via network request, etc.). In some implementations, a tool repository 56 can be periodically updated, and data describing a plurality of WASM compilers 46-1 to 46-N can be periodically updated (e.g., responsive to updates to the tool repository 56, etc.).

In some implementations, causing an instruction file to be compiled into a WASM binary format can include substituting one or more WebAssembly System Interface (WASI)-compatible compile-time dependency equivalents 54-1 to 54-N for one or more non-WASI-compatible compile-time dependencies 42-1 to 42-4. A WASI-compatible compile-time dependency equivalents 54-1 to 54-N can include, for example, a library for performing system calls (e.g., file read/write, display input/output, network input/output, etc.) in a WASM runtime environment. The WASI-compatible compile-time dependency equivalents 54-1 to 54-N can comply, for example, with a WebAssembly System Interface (WASI) standard. In some implementations, functions performed in a WASM runtime environment by a WASI-compatible compile-time dependency equivalent 54-1 to 54-N can be similar to (e.g., same as) functions performed by a non-WASI-compatible compile-time dependencies 42-1 to 42-4 in a non-WASM runtime environment. In some implementations, an appropriate WASI-compatible compile-time dependency equivalent 54-1 to 54-N for substitution can be identified by accessing a data structure (e.g., data structure 51 comprising a set of WASM-compatible compile-time dependencies) correlating non-WASM compile-time dependencies 42-1 to 42-4 (e.g., packages, libraries, individual function calls such as system calls, etc.) with WASI-compatible equivalents 54-1 to 54-N; retrieving a data entry associated with a non-WASM compile-time dependency 42-1 to 42-4 associated with a container build file 6-1, 6-2; and retrieving, based on the data entry, a WASI-compatible compile-time dependency equivalent 54-1 to 54-N.

In some implementations, an attempt to generate a compiled WASM binary may fail (e.g., due to a dropped network connection, unexpected or undetected WASM incompatibility, etc.) and a computing device 4-2 may return an error message explaining the failure. In other instances, a compiled WASM binary 12 may be successfully generated, and a computing device 4-2 can perform additional actions (e.g., as described in the examples set forth below).

In some implementations, a computing device 4-2 can generate (e.g., using a build file generator 30) a new container build file 6-3 for running a compiled WASM binary 12 in a containerized environment (e.g., Docker, Kubernetes, etc.).

A container build file 6-3 can contain, for example, a plurality of build instructions 34-3. Build instructions 34 can be, for example, computer-readable instructions (e.g., Docker instructions, etc.) that, when executed, cause a computing device 4-2 to build a container image. The build instructions 34-3 can include, for example, a reference 38-3 to the compiled WASM binary 12. The reference 38-3 to the compiled WASM binary 12 can include, for example, a filename or storage location associated with a copy of the compiled WASM binary 12. The reference 38-3 to the compiled WASM binary 12 can include, for example, an instruction to include the compiled WASM binary 12 in a container image 42. The build instructions 34-3 can include, for example, a reference 40-3 to a WASM runtime environment 58. The reference 40-3 to a WASM runtime environment 58 can include, for example, a filename or storage location (e.g., URL; git repository location; memory address or storage device location; etc.) associated with the WASM runtime environment 58. The reference 40-3 to a WASM runtime environment 58 can include, for example, an instruction to include the WASM runtime environment 58 in a container image 42. The build instructions 34-3 can include, for example, a reference 40-4 to a WASM runtime dependency equivalent 60. The reference 40-4 to the WASM runtime dependency equivalent 60 can include, for example, a filename or storage location associated with a copy of the compiled WASM runtime dependency equivalent 60. The reference 40-4 to the WASM runtime dependency equivalent 60 can include, for example, an instruction to include the WASM runtime dependency equivalent 60 in a container image 42.

Generating a build file can include, for example, identifying a WASM runtime environment 58 to run the compiled WASM binary 12. In some implementations, an appropriate WASM runtime environment 58 can be identified based on WASM compatibility data (e.g., languages; compile-time dependencies; runtime dependencies). In some implementations, identifying an appropriate WASM runtime environment 58 can include accessing a data structure correlating WASM runtime environments 58 with compatibility data such as languages supported, host APIs supported, compiler framework, compilation or execution mode, operating systems supported, etc.; retrieving a data entry of the data structure associated with one or more properties of a container build file 6-1, 6-2, instruction file 8-1, 8-2 or computing system 4-1, 4-2; and determining, based on the data entry, an appropriate WASM runtime environment 58. Generating the build file 6-3 can also include, for example, identifying one or more WASM runtime dependency equivalents 60 (e.g., according to example methods set forth above) to include in the container build file.

In some implementations, generating a container build file 6-3 can include identifying a WASM equivalent to an instruction in a container build file 6-1, 6-2 being converted to a WASM format. In some implementations, known build patterns 36 can comprise a data structure correlating patterns indicative of non-WASM container build instructions (“e.g. RUN cargo build”) to corresponding instruction patterns for building a WASM-formatted container image (e.g., “RUN cargo build—target wasm32”, etc.). In some implementations, generating a container build file 6-3 can include identifying a non-WASM instruction of the container build file 6-1, 6-2; retrieving, from the known build patterns 36, a data entry associated with the non-WASM instruction; retrieving, from the data entry, a corresponding WASM instruction; and including the WASM instruction in the container build file 6-3.

In some implementations, a container image 42 can be built from the container build file 6-3. The container image 42 can include, for example, a WASM runtime environment 58. The container image 42 can include, for example, the compiled WASM binary 12. In some implementations, the container image 42 can include one or more WASM runtime dependency equivalents 60 or other WASM-compatible runtime dependencies 48.

In some implementations, the container image 42 can be used (e.g., by a build file tester 32) to perform one or more tests based on one or more test instructions 62. For example, in some implementations, a computing device 4-2 can cause the one or more test instructions 62 to be executed using a container initiated from the container image 42. For example, the computing device 4-2 can cause a container to be initiated from the container image 42 and can cause an application running in the container to execute the one or more test instructions 62.

In some implementations, executing the test instructions 62 can cause a test output to be generated. In some implementations, an output generated based on the test instructions 62 can be compared to one or more expected test outputs 64. If the generated outputs do not match the expected outputs, the container image 42 can be determined to contain an error. If the generated outputs match the expected outputs 64, then the computing system 4-2 can determine that the container image 42 is error-free or can perform additional actions (e.g., additional tests) to verify the accuracy of the WASM conversion.

In some implementations, a test of the container image 42 can be evaluated based on factors other than an output generated. For example, in some implementations, a test instruction 62 can be executed and a performance (e.g., speed, processor usage, memory usage, electricity usage, etc.) associated with the container image 42 can be measured. In some implementations, the performance associated with a WASM container image 42 can be compared to a performance associated with a non-WASM container image associated with a non-WASM container build file 6-1, 6-2 from which the WASM container image 42 was generated. In some implementations, data indicative of a comparison between two or more performances can be output (e.g., to a user, computing device, or network connection) or stored (e.g., on one or more non-transitory computer-readable media). A performance associated with a container image can include, for example, an amount of one or more resources (e.g., wall time, processor time, electricity, processor cores, floating-point operations, network bandwidth, memory or storage access bandwidth, memory or storage footprint, etc.) used to perform one or more test instructions 62.

In some implementations, the container build file 6-3 or container image 42 can be uploaded to a git repository 66 (e.g., git repository associated with a container build file 6-1, 6-2). A git repository 66 may be part of the same computing system 2 as the computing device 4-2 or a different computing system. In some implementations, a git repository 66 may be distributed across multiple computing systems.

In some implementations, a software architecture of a computing system 4-1, 4-2 can include a plugin architecture. For example, in some instances, WASM compilers 46-1 to 46-N can be, comprise, be comprised by, implement, or be implemented by, a plugin associated with a plugin architecture of a computing system 4-1, 4-2. In some implementations, a data structure 49 defining a set of WASM-compatible runtime dependencies or a data structure 51 defining a set of WASM-compatible compile-time dependencies can be, comprise, be comprised by, implement, or be implemented by, a plugin associated with a plugin architecture of the computing system. In some implementations, a WASM runtime dependency equivalent 60 or WASM compile-time dependency equivalent 54-1 to 54-N can be, comprise, be comprised by, implement, or be implemented by, a plugin associated with a plugin architecture of the computing system. In some implementations, WASM conversion tools 24, 26, 28, 30, or 32 can can be, comprise, be comprised by, implement, or be implemented by a plugin associated with a plugin architecture of the computing system. A plugin can be, for example, a modular software component (e.g., shared library, etc.) configured to interact with a host application via an interface (e.g., services interface, plugin interface, API, etc.). In some implementations, a host application can be configured to run independently of any plugins. In some implementations, a plug-in can be a language-specific plugin comprising tools for analyzing and converting a container build file 6-1, 6-2 associated with a particular programming language (e.g., Java, etc.).

In some implementations, a computing system 4-2 can retrieve updated data or updated software components (e.g., before beginning to convert a container image 6-1, 6-2 to a WASM format). In some implementations, a computing system 4-2 can retrieve a software tool (e.g., plugin, WASM conversion tool 24 to 32, WASM compilers 46-1 to 46-N, WASM equivalents 60, 54-1 to 54-N, etc.) or software update from a tool repository 56. In some implementations, a computing system 4-2 can retrieve updated data, such as updated data structures 11, 49, 51 defining updated WASM compatibility information, etc.

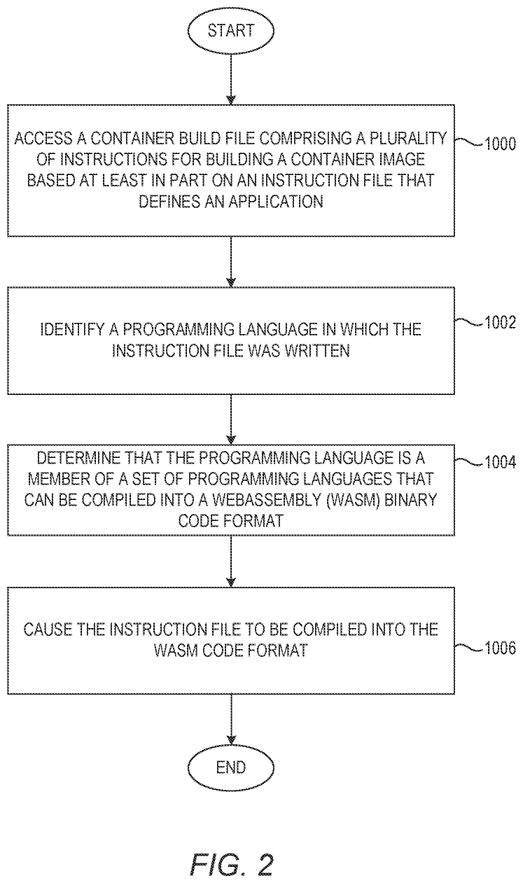

FIG. 2 is a flowchart diagram of an example method, which can be performed by a computing system 2. At 1000, a computing system 2 can access a container build file (e.g., container build file 6-1, 6-2) comprising a plurality of instructions for building a container image based at least in part on an instruction file that defines an application. The instruction file can comprise, for example, an application source code file 8-1 or an application bytecode file 8-2. The container build file can be stored, for example, on the computing system 2 (e.g., on a storage device 20) or on another computing system or device (e.g., connected to the computing system 2 over a network). Accessing can include, for example, retrieving (e.g., from memory), receiving (e.g., over a network), opening, reading, parsing, copying, searching, and the like.

At 1002, a computing system 2 can identify a programming language in which the instruction file was written. Identifying the programming language can include, for example, performing one or more actions described above with respect to FIG. 1.

At 1004, a computing system 2 can determine that the programming language is a member of a set of programming languages that can be converted into a WebAssembly (WASM) binary format. Determining that the programming language is a member of a set of programming languages that can be converted into a WebAssembly (WASM) binary format can include, for example, performing one or more actions described above with respect to FIG. 1.

At 1006, a computing system 2 can cause the instruction file to be compiled into the WASM code format. Causing the instruction file to be compiled into the WASM code format can include, for example, performing one or more actions described above with respect to FIG. 1.

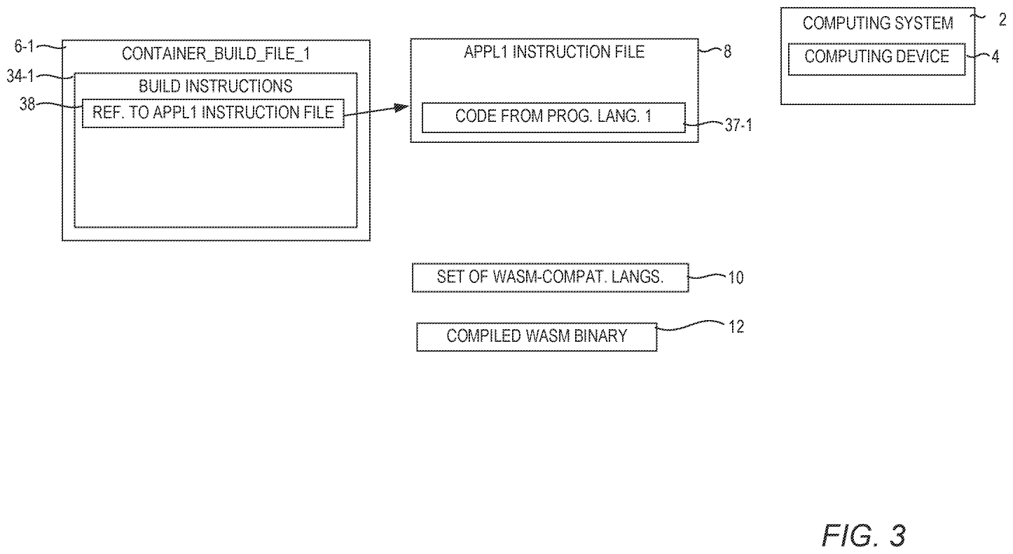

FIG. 3 is a block diagram of an example computing system to convert a container build file to a WASM binary format. A computing system 2 comprising one or more computing devices 4-1 can access a container build file 6-1 comprising build instructions 34-1 for building a container image based at least in part on an instruction file 8-1. The computing system 2 can identify (e.g., based on the build instructions 34-1 or the code from programming language 1 37-1) a programming language in which the instruction file 8-1 was written. The computing system 2 can determine that the programming language in which the instruction file was written is a member of a set of WASM-compatible programming languages 10. Responsive to the determination that the programming language in which the instruction file was written is a member of a set of WASM-compatible programming languages 10, the computing system 2 can cause the instruction file 8-1 to be compiled into a WASM binary format to generate a compiled WASM binary 12.

In some implementations, the parts depicted in FIG. 3 can be, comprise, be comprised by, share similar (e.g., same) properties and operate in a manner similar to (e.g., same as) one or more examples set forth in the description of FIG. 1 with respect to parts sharing a similar (e.g., same) name and part number. For example, an instruction file 8 can be, comprise, be comprised by, or share one or more properties with a source code file 8-1 or bytecode file 8-2.

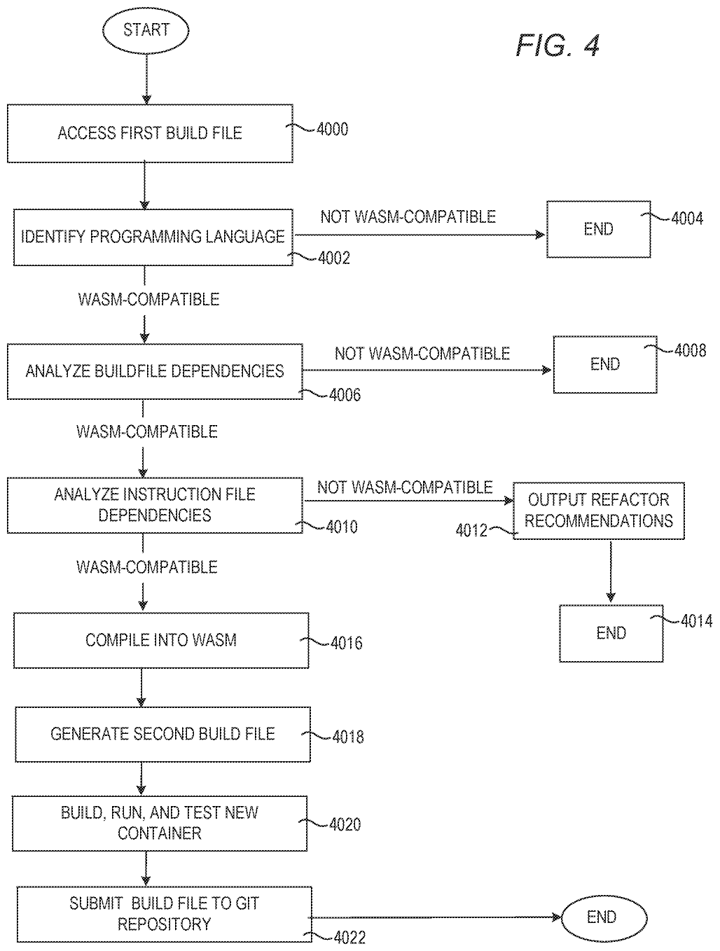

FIG. 4 is an example flow diagram of an example method implementation, which can be performed by a computing system 2. A computing system 2 can, at 4000, access a first build file (e.g., container build file 6-1, 6-2) and, at 4002, identify a programming language associated with it. At 4002, the computing system 2 can determine whether the programming language is WASM-compatible. Identifying the programming language and determining compatibility can include, for example, performing one or more example actions set forth above with respect to FIG. 1. Responsive to the determination, the computing system 2 can either end the method at 4004 (e.g., with a user message indicating that the first build file is not WASM-compatible) or perform one or more additional actions starting at 4006.

At 4006, the computing system 2 can analyze the build file to identify one or more dependencies (e.g., runtime dependencies, compile-time dependencies) associated with the first build file. At 4006, the computing system 2 can determine whether the dependencies identified based on the build file are WASM-compatible. Identifying dependencies and determining compatibility can include, for example, performing one or more example actions set forth above with respect to FIG. 1. Responsive to the determination, the computing system 2 can either end the method at 4008 (e.g., with a user message indicating that one or more dependencies are not WASM-compatible) or perform one or more additional actions starting at 4010.

At 4010, the computing system 2 can analyze an instruction file associated with the first build file (e.g., source code file 8-1, bytecode file 8-2, instruction file 8-1, etc.) to identify one or more dependencies (e.g., runtime dependencies, compile-time dependencies) associated with the instruction file. At 4010, the computing system 2 can determine whether the dependencies identified based on the instruction file are WASM-compatible. Identifying dependencies and determining compatibility can include, for example, performing one or more example actions set forth above with respect to FIG. 1. Responsive to the determination, the computing system 2 can either perform one or more additional actions starting at 4016 or end the method at 4014 after outputting refactoring recommendations at 4012. Refactoring recommendations can include, for example, an identification of one or more dependencies associated with the instruction file that cannot be converted to WASM. In some implementations, refactoring recommendations can further include one or more suggested replacement dependencies (e.g., packages, libraries, etc.) that can be converted to WASM and perform functions similar to (e.g., same as) functions performed by the dependencies associated with the instruction file that cannot be converted to WASM.

At 4016, the computing system 2 can cause an instruction file associated with the first build file to be compiled into a WASM binary format. Causing the instruction file to be compiled into a WASM binary format can include, for example, performing one or more example actions set forth above with respect to FIG. 1.

At 4018, the computing system 2 can generate a second build file. Generating the second build file can include, for example, performing one or more example actions set forth above with respect to FIG. 1. The second build file can comprise, for example, a compiled WASM binary generated based on an instruction file associated with the first build file.

At 4020, the computing system 2 can build, run, and test a new container based on the second build file. Building, running, and testing can include, for example, performing one or more example actions set forth above with respect to FIG. 1. Building can include, for example, building a container image based on the second build file. Running can include, for example, initiating a container based on the container image built from the second build file. Testing can include, for example, performing one or more tests (e.g., based on test instructions 62) using the container initiated from the container image.

In some implementations, a computing system 2 at 4022 can submit (e.g., upload, push, store, etc.) the second build file to a storage location, such as a git repository (e.g., git repository 66). Submitting the second build file can include, for example, performing one or more example actions set forth above with respect to FIG. 1. In some implementations, the git repository can be the same as or different from a git repository associated with the first build file. In some implementations, a second build file can be stored in a different location (e.g., different folder, filename, etc.) within a same git repository in which the first build file is stored. In some implementations, the computing system 2 at 4022 can submit files other than the second build file (e.g., second container image; files to be used in combination with the second build file, such as dependencies, READMEs, etc.) to the git repository, either instead of or in addition to the second build file.

FIG. 5 is a block diagram of the computing device 530 suitable for implementing examples according to one example. The computing device 530 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 530 includes the processor device 532, the system memory 550, and a system bus 546. The system bus 546 provides an interface for system components including, but not limited to, the system memory 550 and the processor device 532. The processor device 532 can be any commercially available or proprietary processor.

The system bus 546 may be any of several types of bus structures that may further interconnect to a memory bus (with or without a memory controller), a peripheral bus, and/or a local bus using any of a variety of commercially available bus architectures. The system memory 550 may include non-volatile memory 552 (e.g., read-only memory (ROM), erasable programmable read-only memory (EPROM), electrically erasable programmable read-only memory (EEPROM), etc.), and volatile memory 551 (e.g., random-access memory (RAM)). A basic input/output system (BIOS) 570 may be stored in the non-volatile memory 552 and can include the basic routines that help to transfer information between elements within the computing device 530. The volatile memory 551 may also include a high-speed RAM, such as static RAM, for caching data.

The computing device 530 may further include or be coupled to a non-transitory computer-readable storage medium such as the input device interface 560, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The input device interface 560 and other drives associated with computer-readable media and computer-usable media may provide non-volatile storage of data, data structures, computer-executable instructions, and the like.

A number of modules can be stored in the input device interface 560 and in the volatile memory 551, including an operating system 556 and one or more program modules, such as the WASM conversion module 561, which may implement the functionality described herein in whole or in part. All or a portion of the examples may be implemented as a computer program product 558 stored on a transitory or non-transitory computer-usable or computer-readable storage medium, such as the storage device 554, which includes complex programming instructions, such as complex computer-readable program code, to cause the processor device 532 to carry out the steps described herein. Thus, the computer-readable program code can comprise software instructions for implementing the functionality of the examples described herein when executed on the processor device 532. The processor device 532, in conjunction with a file transfer module in the volatile memory 551, may serve as a controller, or control system, for the computing device 530 that is to implement the functionality described herein.

An operator, such as a user, may also be able to enter one or more configuration commands through a keyboard (not illustrated), a pointing device such as a mouse (not illustrated), or a touch-sensitive surface such as a display device. Such input devices may be connected to the processor device 532 through an input device interface 560 that is coupled to the system bus 546 but can be connected by other interfaces such as a parallel port, an Institute of Electrical and Electronic Engineers (IEEE) 1394 serial port, a Universal Serial Bus (USB) port, an IR interface, and the like. The computing device 530 may also include the communications interface 562 suitable for communicating with a network as appropriate or desired. The computing device 530 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
accessing, by a computing system comprising one or more computing devices, a container build file comprising a plurality of instructions for building a container image based at least in part on an instruction file that defines an application;
identifying, by the computing system, a programming language in which the instruction file was written;
determining, by the computing system, that the programming language is a member of a set of programming languages that can be compiled into a WebAssembly (WASM) binary code format; and
causing, by the computing system, the instruction file to be compiled into the WASM binary code format.

2. The method of claim 1, further comprising:
identifying, by the computing system, a compile-time dependency of the instruction file; and
determining, by the computing system, that the compile-time dependency is a member of a set of compile-time dependencies that can be compiled into the WASM binary code format.

3. The method of claim 2, wherein determining that the compile-time dependency is a member of the set of compile-time dependencies that can be compiled into the WASM binary code format comprises:
accessing, by the computing system, a data structure comprising WASM compatibility information for a plurality of compile-time dependencies associated with the programming language;
retrieving, by the computing system, from the data structure, a data entry corresponding to the compile-time dependency; and
determining, based on the data entry, that the compile-time dependency is a member of the plurality of compile-time dependencies that can be compiled into the WASM binary code format.

4. The method of claim 2, wherein causing the instruction file to be compiled comprises:
identifying, by the computing system, a WebAssembly System Interface (WASI)-compatible equivalent to the compile-time dependency; and
causing, by the computing system, the instruction file to be compiled into the WASM binary code format using the WASI-compatible equivalent.

5. The method of claim 4, wherein identifying the WASI-compatible equivalent comprises:
accessing, by the computing system, a data structure that correlates a plurality of compile-time dependencies associated with the programming language to a plurality of WASI-compatible equivalents;
identifying, by the computing system, in the data structure, a data entry corresponding to the compile-time dependency; and
retrieving, by the computing system, from the data entry, a reference to the WASI-compatible equivalent to the compile-time dependency.

6. The method of claim 4, wherein the compile-time dependency comprises a system call.

7. The method of claim 1, wherein the container build file is a first container build file, and further comprising:
generating, by the computing system, a second container build file comprising an instruction for building a second container image such that the second container image comprises a WASM module generated by compiling the instruction file into the WASM binary code format.

8. The method of claim 7, further comprising:
generating, by the computing system, the second container image based on the second container build file.

9. The method of claim 8, further comprising:
initializing, by the computing system, a container based on the second container image;
executing, by the computing system, using the container, a test instruction to generate a test output; and
comparing, by the computing system, the test output to an expected test output.

10. The method of claim 8, further comprising:
initializing, by the computing system, a second container based on the second container image;
executing, by the computing system, a test instruction using the second container;
measuring, by the computing system, a performance of the second container in executing the test instruction; and
comparing, by the computing system, the performance of the second container to a performance of a first container generated based on the first container build file.

11. The method of claim 7, further comprising:
identifying, by the computing system, a runtime dependency associated with the first container build file; and
determining, by the computing system, that the runtime dependency is a member of a set of runtime dependencies that are compatible with a WASM runtime environment.

12. The method of claim 11, wherein generating the second container build file comprises:
identifying, by the computing system, a WASM equivalent of the runtime dependency; and
including in the second container build file, by the computing system, an instruction to include the WASM equivalent in the second container image.

13. The method of claim 7, wherein the second container build file comprises an instruction to include a WASM runtime environment in the second container image.

14. The method of claim 1, wherein identifying the programming language comprises identifying a pattern associated with the programming language in the container build file.

15. The method of claim 1, wherein the instruction file comprises bytecode.

16. The method of claim 1, wherein the instruction file comprises source code.

17. A computing system comprising:
one or more computing devices to:
access a container build file comprising a plurality of instructions for building a container image based at least in part on an instruction file that defines an application;
identify a programming language in which the instruction file was written;
determine that the programming language is a member of a set of programming languages that can be compiled into a WebAssembly (WASM) binary code format; and
cause the instruction file to be compiled into the WASM binary code format.

18. The computing system of claim 17, wherein the one or more computing devices are further to:
identify a dependency of the instruction file; and
determine that the dependency is a member of a set of dependencies that can be compiled into the WASM binary code format.

19. The computing system of claim 17, wherein the container build file is a first container build file, and the one or more computing devices are further to:
generate a second container build file comprising an instruction for building a second container image such that the second container image comprises a WASM module generated by compiling the instruction file into the WASM binary code format.

20. A non-transitory computer-readable storage medium that includes executable instructions to cause one or more processor devices to:
access a container build file comprising a plurality of instructions for building a container image based at least in part on an instruction file that defines an application;
identify a programming language in which the instruction file was written;
determine that the programming language is a member of a set of programming languages that can be compiled into a WebAssembly (WASM) binary code format; and
cause the instruction file to be compiled into the WASM binary code format.
